(19) United States
(12) Patent Application Publication
(10) Pub. No.: US 2006/0169783 A1
(43) Pub. Date: Aug. 3, 2006

(54) Color identification system

(76) Inventor: Todd K. Gagne, Lincoln, RI (US)

Correspondence Address: LITMAN LAW OFFICES, LTD, PO BOX 15035, CRYSTAL CITY STATION, ARLINGTON, VA, 22215, US

(21) Appl. No.: 11/322,290

(22) Filed: Jan. 3, 2006

Related U.S. Application Data
(60) Provisional application No. 60/647,797, filed on Jan. 31, 2005.

(51) Int. Cl. G06K 19/00

(52) U.S. Cl. 235/487

(57) ABSTRACT

The color identification system associates a color to a reference symbol. One reference symbol is assigned to each color in the color spectrum. The reference symbol can be used on products, clothes, web sites, traffic signs, etc. When using the color identification system with clothing, a tag or other label is attached to a first article of clothing displaying the reference symbol corresponding to the color of the first article and a chart listing color-coordinating combinations for related articles of clothing and accessories. Each of the items listed in the chart coordinate with the first article of clothing and is identified by its own reference symbol. The reference symbol can also be used to color coordinate house furnishings, such as rugs, furniture, drapes, etc., and to identify items bearing color identification systems, such as electrical wires.

### CROSS-REFERENCE TO RELATED APPLICATION

This application claims the benefit of U.S. Provisional Patent Application Ser. No. 60/647,797, filed Jan. 31, 2005.

### BACKGROUND OF THE INVENTION

1. Field of the Invention

The present invention relates to color identification systems and methods. In particular, the invention is a color identification system for assisting color-blind individuals in distinguishing and deciphering colors.

2. Description of the Related Art

Color is an omnipresent part of life that is sometimes used to distinguish, highlight and identify objects. Color is often used on web sites, on maps, and in controlling and directing traffic. To survive in our multi-colored society, color-blind individuals must find a way to compensate for their inability to see colors. For instance, simple tasks, such as selecting, purchasing and wearing matching clothes, are difficult for the color-blind. In order to coordinate and select clothes, many color-blind individuals seek help from color-seeing individuals. A similar problem can arise in selecting furniture to match the color of walls or rugs. Certain color combinations are deemed aesthetically incongruous or garish, and can subject the color-blind individual to ridicule and humiliation.

Color-blindness can also be a handicap in conducting everyday tasks and can limit job choices. For instance, electrical wires are color-coded and require accurate color readings. Thus, a color identification system to help color-blind individuals identify colors, and also to choose aesthetically pleasing color combinations, is desired.

### SUMMARY OF THE INVENTION

The color identification system associates a color to a reference symbol, e.g., a graphical or geometric shape or icon. One reference symbol is assigned to each color in the color spectrum. The reference symbol can be used on clothes, web sites, traffic signs, etc. When using the color identification system with clothing or other products, a tag or other label is attached to the product. The tag displays the reference symbol corresponding to the color of the product, and also a chart listing color-coordinating combinations for complementary products, e.g., articles of clothing and accessories that are worn together, furniture and furnishings that may be used in the same room, etc. Each of the items listed in the chart coordinate with the product, and corresponding labels or tags are attached to the related products.

For instance, on a black pair of pants the tag attached to the pants would display the reference symbol for the color black and a chart listing secondary articles of clothing and coordinating color combinations for each of the secondary articles of clothing. Some secondary articles for the pants include a shirt, a tie, socks, a belt, etc. The secondary articles are listed in the chart with the reference symbol for a particular color that complements and can be worn with the black pair of pants. One color combination can direct the user to wear a white shirt, a red tie, black socks and a black belt, each color being identified by its own reference symbol. Another color combination can direct the user to wear a red shirt, red sock, etc.

With this system and method of labeling products, color-blind individuals, as well as color-seeing individuals, can choose a color-coordinated outfit from the chart. The system can also be used for selecting and color coordinating house furnishings, such as rugs, furniture, drapes, etc., in order to assist individuals in decorating a home. Likewise, the symbols can be used to identify other color-bearing or color-coded products, such as electrical wires, traffic signs, etc.

These and other features of the present invention will become readily apparent upon further review of the following specification and drawings.

### BRIEF DESCRIPTION OF THE DRAWINGS

FIG. 1 is an environmental perspective view of a color identification system according to the present invention.

FIG. 2 is a reference symbol chart of a color identification system according to the present invention.

FIG. 3 is a front view of a first tag bearing the color identification system according to a first embodiment of the present invention.

FIG. 4 is a front view of a second tag bearing the color identification system according to the first embodiment of the present invention.

FIG. 5 is a front view of a first tag bearing a color identification system according to a second embodiment of the present invention.

FIG. 6 is a front view of a second tag bearing the color identification system according to the second embodiment of the present invention.

Similar reference characters denote corresponding features consistently throughout the attached drawings.

### DETAILED DESCRIPTION OF THE PREFERRED EMBODIMENTS

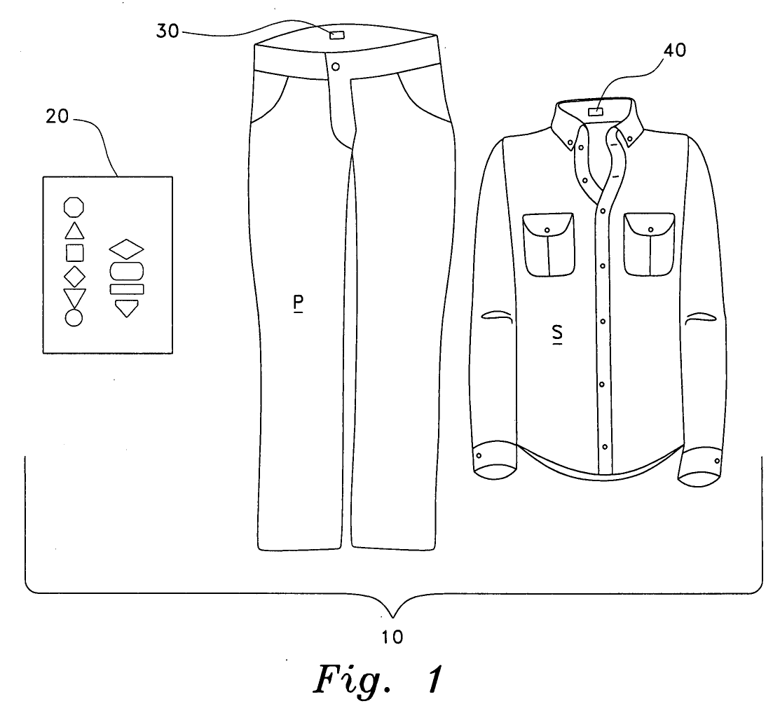

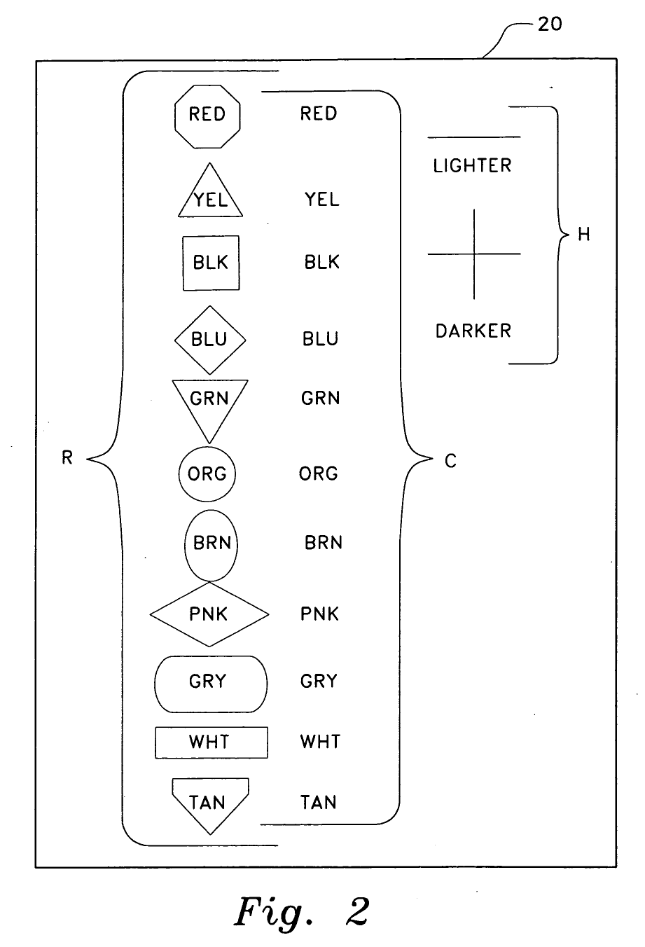

The present invention is a color identification system, designated generally in the figures as 10, that associates a color to a reference symbol. As shown in FIGS. 1 and 2, the system 10 includes a reference symbol chart 20 displaying the reference symbols R identifying the colors C, and also includes tags 30, 40 attached to articles P, S, respectively. The tags 30 and 40 bear an appropriate reference symbol R identifying the color C of each of the articles P, S, as well as reference symbols indicating suitable matching colors for the product to which the tag is attached.

The chart 20 identifies colors C by the reference symbol R using a symbol, e.g., a graphical image or icon or geometric shape, together with indicia in the form of letters that either spell out the complete name of the color or an accepted abbreviation thereof (red associated with an octagon, yellow with an upright equilateral triangle, black associated with a square, etc.), although in some embodiments of the invention the literal indicia disposed within the symbol R may be omitted, the legend on the chart 20 being sufficient to identify the color C associated with the corresponding symbol R. The chart 20 identifies shades of color by a hue section H. The hue section H identifies lighter shades of a color C by a minus sign, while darker shades of a color C are identified by a plus sign. It will be obvious to those skilled in the art that the hue indicator is not restricted to plus and minus signs, but may comprise any desired pair of hue indicator signs. The colors C displayed on the chart 20 in FIG. 2 and the associated symbol R are representative only, and the system may include a greater number of colors and different symbols R corresponding to each color C, as well as different symbols corresponding to the hue H. The reference symbols R can be used in conjunction with various products, such as clothing articles, furniture and furnishings, web sites, traffic signs, etc. When using the color identification system 10 with clothing articles, such as pants P and shirt S, tags or labels 30 and 40 may be permanently or removably attached to the articles P, S.

Referring to FIGS. 1, 3 and 4, the tags 30 and 40 display a reference symbol R corresponding to the color C of the articles P, S, respectively. Tag 30 is attached to the pants P having a black color, and tag 40 is attached to the shirt S having a white color. Tag 30 has a product color identification field 32 and at least one related product color identification field 34.

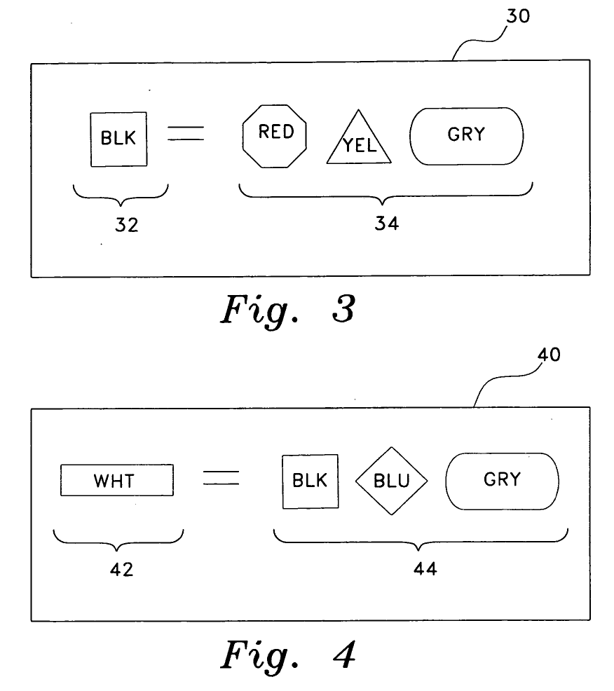

The product color identification field 32 displays the reference symbol R for the color black and therefore identifies the color of the pants P. The related product color identification field 34 displays reference symbols R that complement and coordinate with the color identified in the field 32. In the example shown in FIG. 3, the field 34 declares that the colors red, yellow and gray, each color C being identified by its own reference symbol R, can be worn with the black pants P. Some related products that may be worn with the pants P include shirts, ties, socks, belts, etc.

Likewise, tag 40 has a product color identification field 42 and a related product color identification field 44. Field 42 identifies the color of the article to which tag 40 is attached. The related product color identification field 44 displays the reference symbols R for colors that complement and coordinate to the color identified in the field 42. The field 42 displays the reference symbol R for the color white. The field 44 displays colors that complement and coordinate with the color identified in field 42. Thus, the white colored shirt S can be worn with clothing that is black, blue or gray.

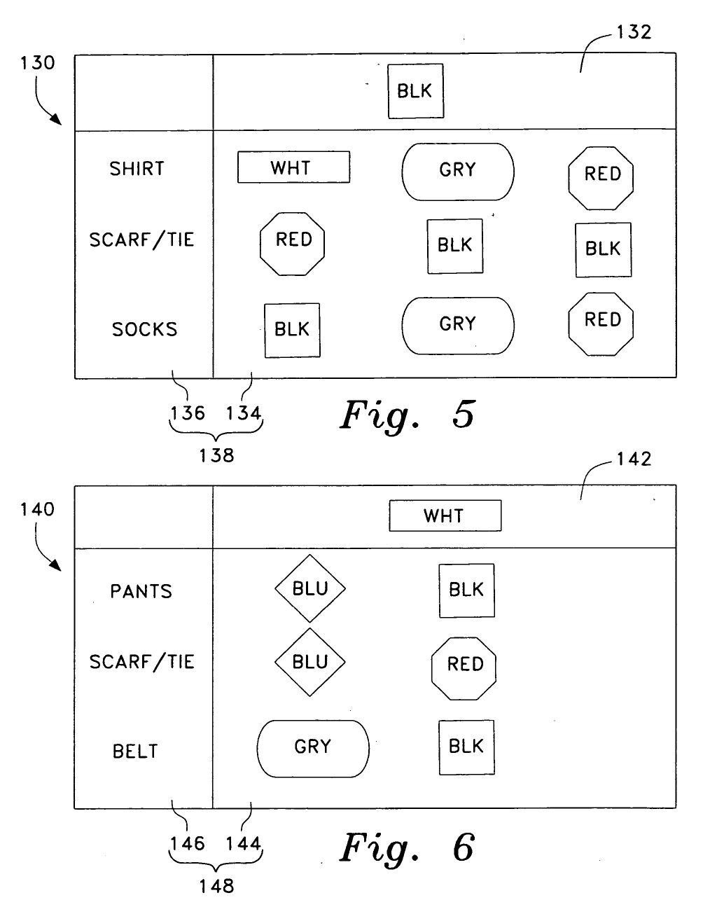

Referring now to FIGS. 5 and 6, in a second embodiment, product tags may appear as shown by tags 130 and 140. Each tag 130, 140 has a product color identification field 132, 142 and a color-coordinating outfit chart 138, 148, which includes a coordinating color field 134, 144 corresponding to a related product field 136, 146. The product color identification fields 132, 142 identify the color of the product to which the tags 130, 140 are attached. The related product color identification field 136, 146 lists items that may be worn with the product to which the tags 130, 140 are attached.

The color-coordinating outfit chart 138, 148 lists possible color combinations complementing and matching the product color displayed in field 132, 142 to create a color-coordinated outfit. The related product color identification fields 136, 146 list related products that may be worn with the product to which the tags 130, 140 are attached. The coordinating color field 134, 144 lists possible color combinations complementing and matching the product color displayed in field 132, 142.

As applied to clothing, tag 130 may be attached to pants, and displays the reference symbol R for the color black in the product field 132. The related product color identification field 136 lists related products, such as shirts, scarves/ties, and socks. Matching color combinations, identified by the reference symbols R, are displayed in the field 134 for each of the listed related products in field 136. Thus, the chart 138 displays color-coordinated outfits for the product to which the tag 130 is attached.

According to tag 130, with the black colored pants P, a user may select a white shirt, a red tie and black socks, as indicated by the first column of color coordinating fields 134. In another outfit color combination, users may be directed to wear a gray shirt, a black tie and gray socks, as indicated by the second column of color coordinating fields 134. In still another color combination, the user can be directed to wear a red shirt, a black tie and red socks, as indicated by the third column of color coordinating fields 134.

Tag 140, attached to the shirt S, displays the reference symbol R for the color white in the product field 142. The related product color identification field 146 lists related products, such as pants, scarves/ties, and belts. The reference symbols R in the color coordinating field 144 identify matching color combinations for each of the listed related products in field 136. Thus, according to the chart 148 of tag 140, the white colored shirt S may be worn with blue pants, a blue scarf or tie and a gray belt, as indicated by the first column of color coordinating fields 144. Alternatively, the white shirt S can be worn with black pants, a red scarf or tie and a black belt, as indicated by the second column of color coordinating fields 144. The number or variety of color-coordinated outfits listed on the tags 130, 140 for the product to which the tags 130, 140 are attached is limitless.

When the system 10 is used to label products, such as in the clothing industry, individual reference symbols R are assigned to individual colors C, and each of the reference symbols R and the colors C are displayed in the reference symbol chart 20. Then the reference symbols R are used to identify the color C of the articles of clothing P, S using tags 30, 40, 130, 140. The tags 30, 40, 130, 140 will also identify and distinguish colors that coordinate and match with the color C of the article of clothing P, S using the reference symbols R. The coordinating or matching colors may be displayed, in general, as shown with tags 30 and 40 or in an organized manner, as shown in charts 138, 148. The charts 138, 148 both list the related products 136, 146 and the matching colors 134, 144 that coordinate with the article of clothing P, S. Thus, secondary articles of clothing P, S may be selected by referencing the coordinating and matching colors displayed in the tags 30, 40, 130, 140.

With this system 10, color-blind individuals as well as color-seeing individuals can select a color-coordinated outfit from the chart 138, 148. The reference symbol R can also be used for selecting color-coordinated house furnishings, such as rugs, furniture, drapes, etc., in order to assist individuals in decorating a home. Likewise, the symbols can be used to identify color-bearing objects, such as electrical wires, traffic signs, etc.

A method of labeling a family of color-coordinated products may include the steps of: establishing a chart associating each color with a corresponding symbol; attaching a label with a symbol corresponding to the product's color to each product in the family; and labeling each of the products with a chart containing color symbols of coordinating colors for related products in the family. The method may further comprise associating literal indicia with the symbols on the labels identifying the color corresponding to the symbol.

Further, the system, labeling, and method described herein can be readily incorporated into a computer-based system suitable for purchase over the Internet. With the computer and web sites each processing the same information, e.g., legend and tag system, choosing and purchasing color-coordinated items will be made available to color-blind individuals, e.g., by a hyperlink to a web page displaying a reference symbol for the product of interest, related products, and a legend either on the merchant's web site or on a web site dedicated to providing color coordination assistance.

It is to be understood that the present invention is not limited to the embodiments described above, but encompasses any and all embodiments within the scope of the following claims.

I claim:

1. A color identification system, comprising:
a reference symbol chart displaying a plurality of reference symbols, each of the reference symbols uniquely identifying a color; and
a tag adapted for labeling a product, the tag bearing one of the reference symbols defining a product reference symbol identifying the color of the product.

2. The color identification system according to claim 1, wherein each of said reference symbols comprises a symbol selected from the group consisting of a graphical image, an icon, and a geometric shape.

3. The color identification system according to claim 1, wherein each of said reference symbols further comprises indicia imprinted on the chart, the indicia naming the colors identified by said reference symbols.

4. The color identification system according to claim 1, wherein said tag further comprises a product color identification field and a related product color identification field, said product reference symbol being disposed in the product color identification field, the related product color identification field having at least one related product reference symbol disposed therein selected from the chart of reference symbols and identifying a related product color, the related product color being color coordinated with the color of the product, whereby a color-blind individual may pair the product with a color coordinated related product when the related product bears a related product tag displaying a corresponding one of said reference symbols.

5. The color identification system according to claim 1, wherein said chart further comprises at least one pair of hue signs for indicating lighter and darker hues of the colors.

6. The color identification system according to claim 5, wherein said pair of hue signs comprises a minus sign for lighter hues and a plus sign for darker hues.

7. The color identification system according to claim 1, wherein said tag further comprises a product color identification field and a color-coordinating outfit chart, the color-coordinating outfit chart including a related product field and a coordinating color field corresponding to the related product field, said product reference symbol being disposed in the product color identification field.

8. The color identification system according to claim 7, wherein said related product field comprises a column listing a plurality of related products and said coordinating color field comprises at least one column of related product reference symbols corresponding to the related products, the related product reference symbols being selected from the chart of reference symbols and identifying a related product color, the related product color being color coordinated with the color of the product, whereby a color-blind individual may pair the product with a plurality of color coordinated related products forming a color coordinated outfit when the related products bear related product tags displaying corresponding said reference symbols.

9. The color identification system according to claim 8, wherein said at least one column of related product reference symbols comprises a plurality of columns of related product reference symbols, whereby a color-blind individual may select among a plurality of color-coordinated outfits.

10. A method of identifying colors, comprising the steps of:
providing a reference symbol chart displaying a legend of a plurality of reference symbols uniquely associated with a corresponding color, the reference symbols being selected from the group consisting of a graphical image, an icon, and a geometric shape;
associating a first article with one of the reference symbols representing the first article's color; and
comparing the first article's reference symbol to the reference symbol chart in order to identify the color of the first article.

11. The method of identifying colors according to claim 10, wherein said first article is represented on a web site on a computer network, said providing step and said associating step further comprising providing a hyperlink to a web page publishing the chart and linking the first article to the first article's color reference symbol.

12. The method of identifying colors according to claim 10, wherein said associating step further comprises the steps of imprinting the first article's color reference symbol on a tag and attaching the tag to the first article.

13. The method of identifying colors according to claim 10, further comprising the steps of:
associating the first article with at least one related second article reference symbol representing a related second article color, the related second article color being color coordinated with the first article's color; and
associating the second article with one of the reference symbols representing the second article's color.

14. The method of identifying colors according to claim 10, further comprising the steps of:
associating the first article with a list of related second articles, the first article and the related second articles forming an outfit;
listing related second article reference symbols corresponding to the related second articles, the related second article reference symbols being selected from the chart of reference symbols and identifying a related second article color, the related second article color being color coordinated with the color of the first article;
associating the listing of related second article reference symbols with the list of related second articles; and
associating each of the related second articles with one of the reference symbols representing the second article's color, whereby color coordinated outfits may be formed.

15. A method of labeling a family of color-coordinated products, comprising the steps of:
(a) establishing a chart associating each color with a corresponding reference symbol;
(b) attaching a label with one of the reference symbols to each of the products, the reference symbol corresponding to the color of the product to which the label is attached; and
(c) labeling each of the products with a chart containing reference symbols of coordinating colors for related products in the family.

16. The method of labeling according to claim 15, wherein step (c) further comprises listing a group of the related products forming an outfit on the chart, each of the related products having one of the coordinating colors associated therewith, whereby a color coordinated outfit may be selected.
